(19) United States
(12) Patent Application Publication
(10) Pub. No.: US 2021/0223280 A1
(43) Pub. Date: Jul. 22, 2021

(54) Hot-Wire Anemometer

(71) Applicant: AZ INSTRUMENT CORPORATION, Taichung City (TW)

(72) Inventor: Chen Heng CHENG, TAICHUNG CITY (TW)

(21) Appl. No.: 17/151,480

(22) Filed: Jan. 18, 2021

(30) Foreign Application Priority Data
Jan. 22, 2020 (TW) 109201013

(51) Int. Cl. G01P 5/12

(52) U.S. Cl. CPC G01P 5/12

(57) ABSTRACT

A hot-wire anemometer comprises a probe. The probe has a probe head disposed at an end thereof. The probe head has an elongated narrow hole or a plurality of round holes being provided with at least a metal wire segment extending in an axial direction of the probe head to enlarge a contact area between the metal wires and a fluid. According to an average temperature of the larger area, a more accurate wind velocity is measured.

### BACKGROUND

### Technical Field

The present disclosure is directed to a hot-wire anemometer, especially a hot-wire anemometer for measuring an average wind velocity of a large area.

### Related Art

Most conventional hot-wire anemometers have two temperature transmitters on a probe, one is heated to make the temperature higher than the temperature of the fluid, and the other is deployed to measure the temperature of the fluid, according to the difference between the two temperatures, the wind velocity of the fluid is calculated. There are two common designs, principles and functions are outlined as follows: the first design is as disclosed in FIG. 18 of US20150308874A1. There are two holes on the probe for fluid flowing through, a small heat sensitive thermistor being disposed in each hole for measuring the fluid velocity in the hole. The second design is as disclosed in FIG. 2 of U.S. Pat. No. 9,696,335B2, which is the most original hot-wire anemometer, comprising a temperature transmitter being configured at one location, and a piece of metal wire being supported by a bracket at the other location.

In the first design, due to the small volume of a heat sensitive thermistor, the contact area is very small, and the measured wind velocity is only a small portion of the hole, and the fluid velocity in the hole cannot be measured. Although the second design can measure the temperature of a longer line, it is an open structure, the measurement space is large, and the measurable range of the wind velocity is relatively small.

When the fluid passes through the hole, due to the friction around the hole and the change in a cross-sectional area, the fluid velocity at each point in the hole varies greatly, especially at the periphery of the hole, turbulence is likely to occur, so the measurement of a small area cannot accurately measure the fluid velocity in the hole.

### SUMMARY

The present disclosure is directed to a hot-wire anemometer, especially a hot-wire anemometer for measuring an average wind velocity of a large area.

A hot-wire anemometer comprises a probe. The probe has a probe head disposed at an end thereof. The probe head has an elongated narrow hole or a plurality of round holes provided with at least a metal wire segment extending in an axial direction of the probe head. The probe head has a supporting piece disposed in partition in the elongated narrow hole or the round holes.

In some embodiments, at least a metal wire comprises two metal wire segments, a plurality of the metal wire segments being formed by a metal wire looping back and forth along both ends of the elongated narrow hole or the round hole at least once.

Hence, the metal wire segments enlarge a contact area between the metal wire and a fluid. According to an average temperature of the larger area, a more accurate wind velocity is measured.

### BRIEF DESCRIPTION OF THE DRAWINGS

FIG. 1 is a schematic view of a probe of a hot-wire anemometer.

FIG. 2 is a cross-section view of a probe of a hot-wire anemometer.

### DETAILED DESCRIPTION

These and other objects and advantages of the present invention will become readily apparent to those skilled in the art upon reading the following detailed description by referring to the accompanying drawings.

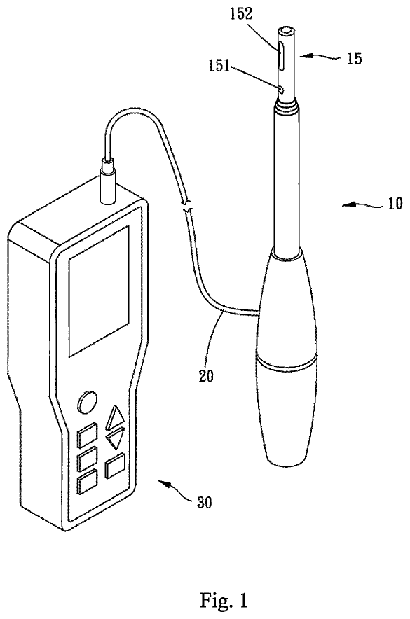

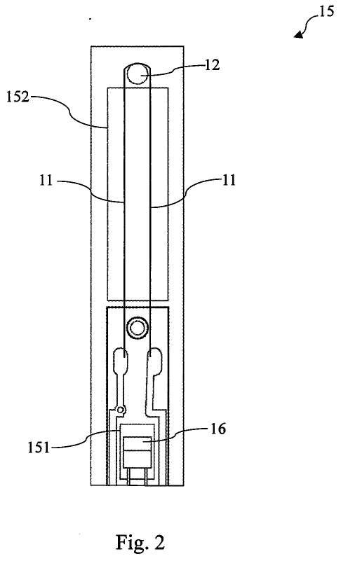

Please refer to FIG. 1-FIG. 2, the instant disclosure provides an embodiment of a hot-wire anemometer, comprising a probe 10, a signal transmission line 20, and an electronic display 30. The signal transmission line 20 is deployed to transmit a measurement result to display on the electronic display 30. In some embodiments, the signal transmission line is replaced with a wireless communication to conduct the transmission.

The probe 10 has a probe head 15 disposed at an end thereof. The probe head 15 has a round hole 151 and an elongated narrow hole 152. The round hole 151 has a temperature transmitter 16 disposed thereof. The elongated narrow hole 152 has a metal wire provided with a supporting piece 12 in the middle section thereof. The metal wire loops back and forth along both ends of the elongated narrow hole 152 to form two metal wire segments 11 disposed in partition in the elongated narrow hole 152. Therefore, taking a cross-section area into consideration, the elongated narrow hole 152 is revolved by the metal wire at least a circle (that is, loops back and forth at least once) to acquire the largest contact area. In some embodiments, a single metal wire segment extends in an axial direction of the probe head, the metal wire segment having a longer length compared to the prior art, thereby enlarging a contact area between the metal wire segment and a fluid.

The supporting piece 12 is deployed to support the metal wire and located at an end of the elongated narrow hole 152. In some embodiments, a plurality of the supporting pieces is disposed respectively at opposite ends of the elongated narrow hole 152 provided with a support point. The support point is a contact or a plug-in of a printed circuit board or a plastic molding column. In some embodiments, the plastic molding column has a protrusion p at an end served as the support point thereof, two contacts of the printed circuit board being served as the support points of both ends of the metal wire, the supporting structure making production more convenient.

In some embodiments, the metal wire comprises at least two metal wires electrically connected. The plurality of the metal wires and the temperature transmitter 16 are connected respectively to a circuit and a printed circuit board. According to the temperature difference between the temperature transmitter 16 and the metal wire, a measurement is calculated.

In some embodiments, the metal wire loops back and forth along both ends of the elongated narrow hole 152 to form two metal wires being disposed in partition therein. The probe head 15 has the supporting piece 12 disposed in partition in the elongated narrow hole 152. The arrangement enlarges the contact area between the air and the metal wire 11, due to each point on the metal wire being contacted with a different wind velocity, temperatures being different as a result. Because a heat conduction of the metal wire is fast, all wires become an isothermal metal wire in seconds to acquire an average temperature of the metal wire, calculating the temperature differences between the average temperature and the sensor, an average wind velocity is calculated.

In some embodiments, the metal wire of the hot-wire anemometer is longer than the metal wire of a conventional anemometer, the elongated narrow hole 152 comprising more locations therein, a fluid velocity being closer to an average fluid velocity of the entire elongated narrow hole 152, thereby elevating the accuracy of the measurement.

In some embodiments, the elongated narrow hole 152 is replaced by a plurality of round holes, the metal wire segments 11 comprises at least one metal wire segment, the axial extending structure enlarging the contact area, thereby elevating the accuracy of the measurement of the average wind velocity.

What is claimed is:

1. A hot-wire anemometer, comprising:
a probe, wherein the probe has a probe head disposed at an end thereof; the probe head has an elongated narrow hole or a plurality of round holes;
wherein the elongated narrow hole or the plurality of round holes has at least a metal wire segment extending in an axial direction of the probe head.

2. The hot-wire anemometer of claim 1, wherein at least a metal wire segment comprises more than two metal wire segments being disposed in partition; wherein the probe head has at least a supporting piece; wherein a plurality of metal wire segments is formed by a metal wire looping back and forth along both ends of the elongated narrow hole or the plurality of round holes.

3. The hot-wire anemometer of claim 1, wherein the plurality of the metal wire segments comprises at least a metal wire.

4. The hot-wire anemometer of claim 2, wherein the supporting piece is located at opposite ends of the elongated narrow hole or the plurality of round holes provided with at least a support point.

5. The hot-wire anemometer of claim 4, wherein at least a support point is a contact or a plug-in of a printed circuit board and/or a plastic molding column.
